(19) United States
(12) Patent Application Publication
(10) Pub. No.: US 2004/0008519 A1
(43) Pub. Date: Jan. 15, 2004

(54) Lighting device

(76) Inventors: Shinichi Todaka, Saitama (JP); Isamu Yoshioka, Saitama (JP)

Correspondence Address: FISH & RICHARDSON P.C., 45 ROCKEFELLER PLAZA, SUITE 2800, NEW YORK, NY, 10111, US

(21) Appl. No.: 10/463,887

(22) Filed: Jun. 18, 2003

(30) Foreign Application Priority Data
Jul. 11, 2002 (JP) 2002-202575

(51) Int. Cl. B60Q 1/00; B60Q 1/26

(52) U.S. Cl. 362/487

(57) ABSTRACT

A lighting device, which has light-emitting diodes, a circuit board, and pedestals. In this lighting device, some of light-emitting diodes are installed on the circuit board through a pedestal, respectively. In this pedestal, a mounting plane, to which the light-emitting diode is mounted, is formed. Since this mounting plane is inclined with respect to the surface of the circuit board, the optic axis of a light-emitting diode faces different direction in compliance with the angle of slanting of this mounting plane.

### BACKGROUND OF THE INVENTION

1. Field of the Invention

The present invention relates to a lighting device adopting a light-emitting diode (LED) . This lighting device is used as the light source of a side turn light installed on the door mirror etc. of a vehicle.

2. Description of the Related Art

A lighting device, which adopts a light-emitting diode (herein after indicated as LED) as a light source, has been known.

The conventional LED consists of a luminous part, which accommodates a luminous chip (LED chip), and two lead wires, which supply electric power with the luminous part (LED chip). Since LED emits light from PN-junction surface of the luminous chip (LED chip), the light emitted from LED has a strong directional orientation. Thus, a visibility of the light emitted from LED declines in the position where it deviated from the optic axis of emitted light.

When LED is applied to the lighting device, such as stop lamp and a side turn (signal) lamp, of a vehicle, the light emitted from LED should be recognized from any directions. Thus, in order to secure the visibility of the light emitted from LED, plurality of LEDs are required in the lighting device. In this occasion, each LED should be positioned on a circuit board of a lighting device so that each optic axis of light emitted from each LED faces a different direction.

When installing LED on the circuit board, LED cannot be installed on the circuit board in the condition that it is inclining with respect to the circuit board because of structural restriction. That is, LED must be vertically installed on the circuit board. Therefore, in the conventional lighting device adopting LED, the optic axis of LED becomes vertical with respect to the circuit board.

When plurality of LEDs are required on the circuit board in the condition that each optic axis of each LED faces different direction, respectively, the circuit boards of the same number as the number of the optic axis are required, or the circuit board having a complicated shape, in which each mounting plane of LED faces the predetermined direction, is required.

As an example of this kind of the conventional lighting device, the lighting device, which adopts the circuit board having a complicated shape, will be explained. FIG. 4 is a sectional view showing the side turn light, which is a lighting device of a vehicle and is installed on the door mirror

A door mirror 200 is positioned at the front end side of a front door D of a vehicle body, and is extended sideward with respect to the vehicle body.

The door mirror 200 has a mirror M for checking the rearward visibility of the vehicle, a body B for storing the mirror M therein, and an inner mechanism N, which swings the door mirror 200 from the non-using position to the use position and adjusts the angle of mirror M.

In the door mirror 200, the lighting device having a plurality of LEDs 201 and 201 is disposed at the periphery part of the body B so that the optic axis of the LED 201 faces in the obliquely rearward direction. By these LEDs, persons around the vehicle are notified that the vehicle equipped with this lighting device is going to turn left or right.

As described above, since LEDs 201 and 201 cannot be installed on circuit board in the slanting condition, the circuit board 202 is divided into circuit boards 202b and 202c in the conventional lighting device. On this occasion, each circuit boards 202b and 202c are electrically connected each other through a jumper wire 203.

Additionally, the circuit board 202b is formed as the stair-like shape so that the optic axis of the LED 201 faces in the obliquely rearward direction, when each of LEDs is vertically installed on the stair surface 202a of the circuit board 202b.

Therefore, in the conventional lighting device, if plurality of circuit boards are required in the lighting device, each circuit board should be connected each other through the jumper wire 203 in order to flash LEDs 201, synchronously. Thereby, the more manufacturing cost and thousands of man-hour for manufacturing the lighting device are required as the number of the jumper wire 103 increases in the lighting device.

Additionally, since the shape of the circuit board 202b should be formed into the complicated shape in order to face the optic axis of each LED 201 toward the desired direction, the further manufacturing processes are required for manufacturing the circuit board 202b and the assembling efficiency of the inner mechanism N becomes worse. Thus, the manufacturing cost of the lighting device becomes further high.

Therefore, there have been required that the technique, which can overcome these disadvantages. In other words, there has been required that the lighting device, which can direct each optic axis of each LED toward the desired direction without providing the circuit board having a complicated shape.

### SUMMARY OF THE INVENTION

The present invention relates to a lighting device. This lighting device has light-emitting diodes, a circuit board, and pedestals. In this lighting device, each light-emitting diode is installed on the circuit board through each pedestal, respectively. In this pedestal, a mounting plane, to which the light-emitting diode is mounted, is formed. Since this mounting plane is inclined with respect to the surface of the circuit board, the optic axis of a light-emitting diode faces different direction in compliance with the angle of slanting of this mounting plane.

According to this lighting device having these constructions, the optic axis of a light-emitting diode can be shifted to the suitable direction by changing the angle of inclination of the mounting plane of the pedestal. Thereby, since the flat plate-shaped circuit board can be used in the lighting device, the manufacturing cost and the efficiency of the assembling of the lighting device can be improved.

### BRIEF DESCRIPTION OF THE DRAWINGS

FIG. 1 is a sectional view showing the side turn light, which adopts the lighting device according to the present invention.

FIG. 2A is an exploded perspective view of the lighting device according to the present invention.

FIG. 2B is a perspective of the lighting device according to the present invention.

FIG. 3 is a perspective view showing another embodiment of the pedestal of the lighting device according to the present invention.

FIG. 4 is a sectional view showing the conventional side turn light.

### DETAILED DESCRIPTION OF THE PREFERRED EMBODIMENTS

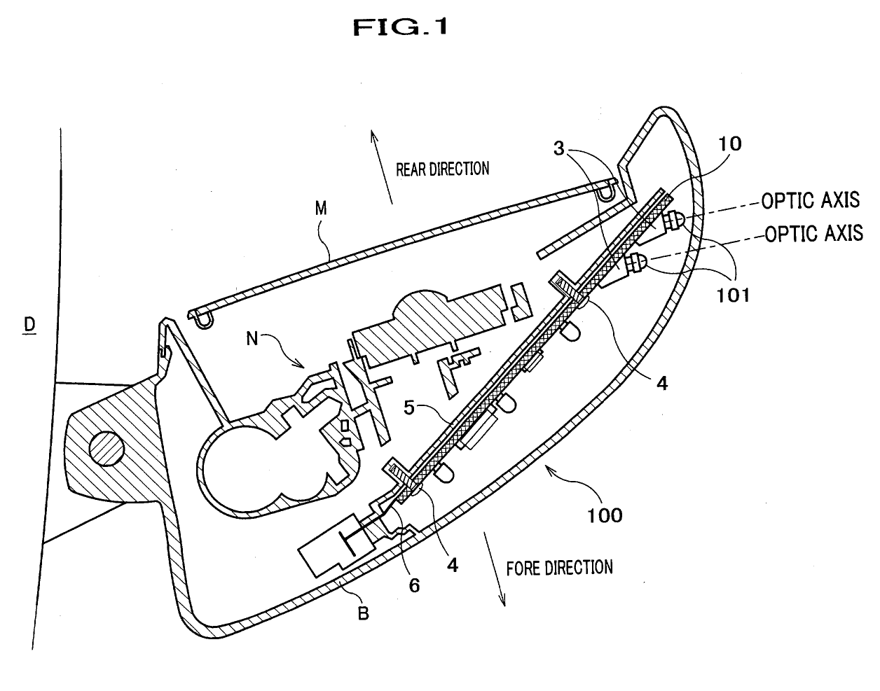

The preferred embodiment of the present invention will be explained with reference to the attached drawings. FIG. 1 is a sectional view showing the side turn light installed on the door mirror, which adopts the lighting device according to the present invention.

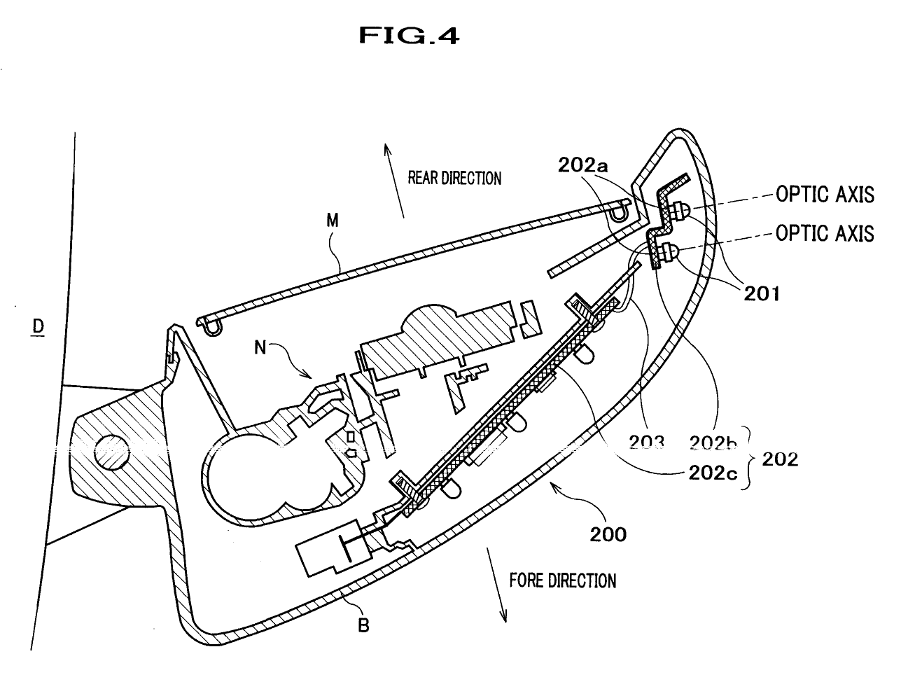

As shown in FIG. 1, the door mirror 100 has a mirror M for checking the rearward visibility of the vehicle, a body B for storing the mirror M therein, and an inner mechanism N, which swings the door mirror 100 from the non-use position to the use position and adjusts the angle of mirror M. The shape of body B of the door mirror 100 and the construction of the inner mechanism N are the same as that of described in the door mirror 200 shown in FIG. 4.

In this door mirror 100, as shown in FIG. 1, since the circuit board 10 is not divided into plural bodies, the shape of the circuit board 10 differs from the circuit board 202 of door mirror 200 shown in FIG. 4.

In the lighting device of the present invention, the circuit board 10 is fixed on a fixing part 5 provided in the body B by screws 4. This circuit board 10 has a connection wire 6, which supplies electric power to the circuit board 10 from a power source (not shown), at the one end part thereof.

In this circuit board 10, some of LEDs are installed on the circuit board 10 through a pedestal 3 made of metallic materials (conducting material) . As can be seen from FIG. 1, since the mounting plane, onto which LED 101 is mounted, of the pedestal 3 is inclining with respect to the surface of the circuit board 10, the optic axis of the light emitted from LED 101 faces the inclined direction with respect to the circuit board 10. That is, in this embodiment, the optic axis of the light emitted from the LED 101 faces the obliquely rearward direction with respect to the vehicle.

In the present embodiment, since some of LEDs 101 are installed on the circuit board 10 through the pedestal 3, the flat plate-shaped circuit board 10 can be adoptable in the lighting device. Thereby, the manufacturing of the circuit board 10 and the assembling of the lighting device can easily be achieved.

In the present invention, furthermore, since the jumper wires 203 used for connecting each circuit plates are not required, the manufacturing cost of the lighting device can be reduced.

In the present embodiment, the lighting device used for the side turn light installed on the door mirror of a vehicle has been described. The lighting device may be applicable for the side turn light disposed on the vehicle body or the stop lamp disposed on the rear of a vehicle body.

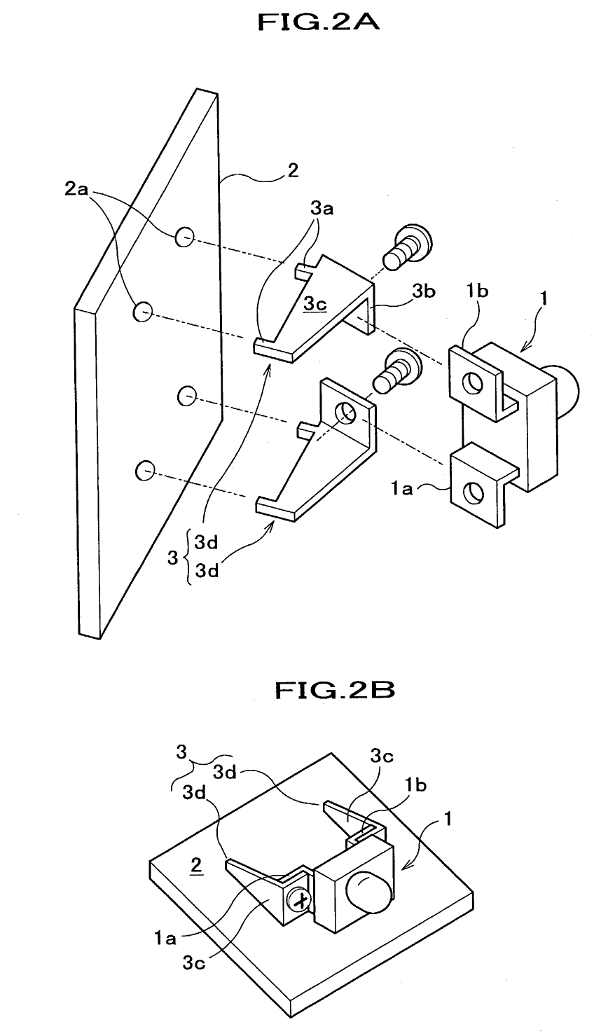

Next the detailed explanation of the pedestal 3 of the lighting device according to the present invention will be carried out with reference to FIG. 2A and FIG. 2B. FIG. 2A is an exploded perspective view of the lighting device according to the present invention. FIG. 2B is a perspective of the lighting device according to the present invention.

As shown in FIG. 2A and FIG. 2B, the pedestal 3 is composed of pair of pedestal blocks 3d and 3d. Each pedestal blocks 3d and 3d is installed on the base plate 2 so that each pedestal blocks 3d and 3d do not contact with each other. One of the pedestal blocks 3d connects with an anode terminal 1a of LED 1, and the other of the pedestal blocks 3d connects with a cathode terminal 1b of LED 1.

Each pedestal blocks 3d and 3d is made of metallic materials (conducting material), and is formed into the suitable shape in order to direct the optic axis of the light to be emitted from LED 1 toward the obliquely rearward direction with respect to the vehicle.

In the present embodiment, since the pedestal 3 is made of metallic materials, an electrical connection between the base plate 2 and LED 1 can be produced. Additionally, since the pedestal 3 is made of metallic materials, LED and pedestal 3 are firmly joined together by soldering. Thus, since the connection between the pedestal 3 and LED is ensured, the quality of the lighting device can be guaranteed. The metallic material, additionally, excels in heat release characteristics, a high intensity LED can be adoptable in the lighting device of the present invention. Here, since the pedestal 3 is composed of pair of pedestal blocks 3d and 3d, large area of the pedestal 3 is exposed to the air. Thus, the present invention's pedestal 3 further excels in hear release characteristics. Additionally, since metallic material excels in moldability, the angle of slanting of the optic axis of LED can easily be adjustable by changing the angle of slanting of the mounting plane.

This pedestal block 3d has a pair of engagement parts 3a and 3a, a joint part 3b, and a base part 3c. The engagement part 3a engages with the hole 2a formed on the base plate 2 in order to fix the pedestal block 3d on the base plate 2. The joint part 3b connects the pedestal block 3d with terminal 1a or 1b of LED 1. The base part 3c gives the electrical connection between the engagement part 3a and the joint part 3b.

The engagement part 3a fixes the pedestal block 3d on the base plate 2, vertically, and brings an electrical connection with the electric circuit formed on the base plate 2. Here, since each parts (the engagement part 3a, the joint part 3b, and the base part 3c) of the pedestal 3 is made of metallic materials, electric power is carried to LED 1, when electric power is supplied to this engagement part 3a from power source (not shown) through the electric circuit.

In the present embodiment, the pedestal block 3d has two engagement parts 3a and 3a. But the numbers of this engagement part 3a is not limited to this. For example, any modification such as number of this engagement part 3a may be adoptable as long as the pedestal block 3d is vertically fixed on the circuit board 10.

The joint part 3b is formed by bending one end of the base part 3c into the L-like shape. This joint part 3b connects with the terminal 1a or 1b of LED 1, and is used for fixing the LED 1 on the pedestal block 3d. By this connection between the joint part 3b and the terminal 1a of LED 1, electric power is carried to LED 1.

In the present embodiment, LED 1 is fixed at the joint part 3b by screw. But this LED 1 may be fixed at the joint part 3b using the caulking or soldering technique as long as LED 1 is firmly fixed on the joint part 3b.

In the present invention, as described above, since LED 1 is firmly fixed at the pedestal 3 through the joint part 3b, the stability of installation condition of LED 1 can be improved. Thereby, the occurrence of the trouble, such as the deviation of the optic axis of LED 1 caused by the vibration of the lighting device, can be prevented.

In the present embodiment, the surface of the joint part 3b (mounting plane) is established so that the surface of the joint part 3b would be inclined with respect to the base plate 2. By this establishment, the optic axis of the light to be emitted from the LED 1 can be directed toward the suitable direction (obliquely upward direction with respect to the base plate 2). In the present embodiment, therefore, the inclined angle of the surface of the joint part 3b is established so as to direct the optic axis of the light to be emitted from the LED 1 toward the obliquely rearward direction with respect to a vehicle when this lighting device is adopted in the door mirror 100 of a vehicle.

The base part 3c has a plate-like shape and is positioned between the engagement part 3a and the joint part 3b. This base part 3c has a trapezium shape in side viewing so that the surface of the joint part 3b inclines with respect to the base plate 2, when the pedestal 3 is assembled on the base plate 2.

In this embodiment, the pedestal 3 is once assembled on the base plate 2 and then installed on the circuit board 10 through the base plate 2. But the assembling manner of this pedestal 3 is not limited to this, for example, this pedestal 3 may be assembled on the circuit board 10 without using the base plate 2. In the present embodiment, furthermore, any shape of the base part 3c may be acceptable as long as the optic axis of the light to be emitted from the LED 1 can be directed toward the desired direction.

In the present invention, each pedestal blocks 3d and 3d is installed on the base plate 2, and LED 1 is fixed at the base plate 2 through the pedestal blocks 3d and 3d. Thus, the direction of optic axis can be adjustable by modifying the shape of the pedestal block 3d and the angle of inclination with respect to the circuit board 10 of the mounting plane of the joint part 3b.

In the present embodiment, pedestal blocks 3d and 3d formed of metallic materials is adopted, but the components of this pedestal block 3d is not limited to this, for example, the components having superior electrical conductivity, such as carbon containing resin materials, can be adoptable.

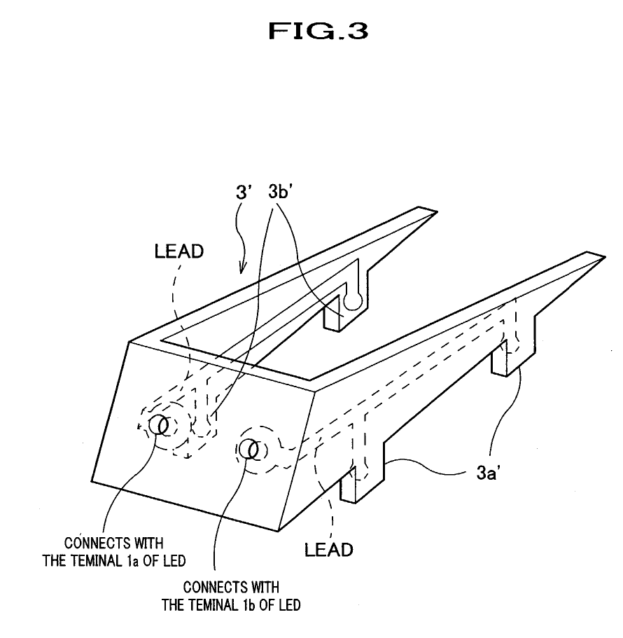

In the present invention, furthermore, the pedestal 3 consisting of pair of pedestal blocks 3d and 3d is adopted. But the pedestal 3 is not limited to this, for example, as shown in FIG. 3, the pedestal 3′, which is made of molded insulating material and has wirings, may be adoptable. In this pedestal 3′, two wirings, one of which connect with the anode terminal 1a of LED 1 and the other of which connect with the cathode terminal 1b of LED 1, are provided separately. By these wirings, electric power is supplied to LED.

What is claimed is:

1. A lighting device comprising:
a light-emitting diode;
a circuit board, onto which said light-emitting diode is installed; and
a pedestal, which has an electrical conductivity, and which installs said light-emitting diode on said circuit board so that an optic axis of a light emitted from said light-emitting diode faces the desired direction.

2. A lighting device according to claim 1, wherein said pedestal has a mounting plane which is inclined with respect to said circuit board, and wherein
said light-emitting diode is mounted on said mounting plane.

3. A lighting device according to claim 2, wherein said pedestal is made of metallic materials.

4. A lighting device according to claim 3, wherein said pedestal consists of pair of pedestal blocks, which are vertically installed on said circuit board.

5. A lighting device according to claim 4, wherein said lighting device is an indicator, which is installed on a vehicle and is used for indicating a motion of said vehicle.

6. A lighting device comprising:
a plurality of light-emitting diodes;
a circuit board, onto which said plurality of light-emitting diodes are installed; and
a pedestal, which has a mounting plane inclining with respect to said circuit board at predetermined inclined angle, and which brings an electrical connection between said light-emitting diodes and said circuit board,
wherein some of said light-emitting diodes are mounted on said mounting plane.

7. A lighting device according to claim 6, wherein said pedestal is composed of pair of pedestal blocks made of metallic material, which are separately provided on said circuit board, and wherein one of said pedestal blocks connects an anode terminal of said light-emitting diode with said circuit board, and the other of said pedestal blocks connects a cathode terminal of said light-emitting diode with said circuit board, separately.

8. A lighting device according to claim 6, wherein said pedestal is made of insulating material, and said pedestal has a pair of wirings, one of said wirings connects an anode terminal of said light-emitting diode with said circuit board, and the other of said wirings connects a cathode terminal of said light-emitting diode with said circuit board, separately.
